(19) United States
(12) Patent Application Publication
(10) Pub. No.: US 2013/0238972 A1
(43) Pub. Date: Sep. 12, 2013

(54) LOOK-ALIKE WEBSITE SCORING

(71) Applicants: Nathan Woodman, Essex, MA (US); Krishna S. Boppana, Boxborough, MA (US); Trevor J. Blackford, Boston, MA (US); Jiankuan Ye, Lexington, MA (US)

(72) Inventors: Nathan Woodman, Essex, MA (US); Krishna S. Boppana, Boxborough, MA (US); Trevor J. Blackford, Boston, MA (US); Jiankuan Ye, Lexington, MA (US)

(21) Appl. No.: 13/416,711

(22) Filed: Mar. 9, 2012

(51) Int. Cl. G06F 17/00

(52) U.S. Cl. 715/234

(57) ABSTRACT

Methods and systems for searching and scoring look-alike web sites are provided. A web crawler can harvest text and page layout data from a website. The context of the text can be analyzed. The page layout data can be condensed. The captured text and page layout data can be stored in a database and searched. A user can provide seed data including a desirable URL and keywords. The seed data can be analyzed and compared to the database. Look-alike web pages can be identified and scored. A page scoring list can be displayed. Look-alike scoring factors can be used in an ad exchange interface.

### BACKGROUND

A growing approach to selling advertising on the Internet is through the use of an ad exchange, which can create a common marketplace for advertisers and publishers. In general, Internet (i.e., web) based advertising relates to populating a website with advertisements. For example, a publisher can sell a certain amount of space on one or more pages associated with a website (e.g., as generally identified by a Uniform Resource Locator (URL) string). In general, the advertising space can be located anywhere on a page, as well within media contained on a page (e.g., text objects, picture and video fields). Typical examples include placing advertisements at the top of a web page (i.e., a banner), along the sides, at the bottom, and on pop-up windows within a web page. The types and locations of website advertisements can vary with technology. In the majority of implementations, the web page advertisements can be linked to the advertiser's website and can allow a user to activate the link with click of a mouse, or other pointer device. Publishers can establish pricing for advertisements based on factors associated with the accessibility of an ad to the user (e.g., size, page location, frequency of presentation).

The accessibility of an advertisement on the web can be further refined based on the accessibility to a particular audience. For example, web pages can be analyzed based on the context of the information on the page, and publisher can align advertisements with the content of the website (e.g., ads for automotive parts on automotive repair websites). A publisher can offer ad space based on a single website, or may provide a package such that an ad will appear on several related websites within the publisher's control. The advertising space can be sold based on the frequency the ad will be displayed (e.g., every third, fourth, fifth user or rendering), and/or how often a user actives the link in the ad (e.g., per click from the user). Other pricing factors and schemes may also be use based on the technical capabilities of the web browser.

In some implementations, an ad exchange can be used as a secondary market to help publishers sell excess ad slots on a web page. The publisher can make the slots available to the ad exchange, and advertisers can bid in near real time to have their ad displayed when the page is rendered. The ad exchange can be configured to accept constraints from the advertisers to help ensure that their ad will reach a target audience. Examples of constraints can include URL lists, pricing, market, time, user location, and other variables to ensure the page displaying the ad is relevant to the advertiser's target audience. Once an ad is placed, the advertiser can analyze the effectiveness of an ad on a particular page. If an ad is effective, the advertiser may seek to place additional ads on similar look-alike web pages. The constraints provided to the ad exchange can be modified to increase the probability that an ad will be placed on a look-alike website.

### SUMMARY

An example of computerized method for identifying look-alike websites according to the disclosure includes receiving one or more URL strings to be harvested, rendering, in at least one computer, a web page associated with each of the URL strings to generate page-structure-based features, analyzing the page-structure-based features for each of the web pages with the computer, storing one or more page-structure-based variables for each of the web pages based on the analysis, receiving a look-alike input seed, calculating, with at least one computer, one or more scoring factors based on the received look-alike input seed and the stored page-structure-based variables, and outputting the scoring factors.

Implementations of such a computerized method may include one or more of the following features. The look-alike input seed includes a URL string. Analyzing the page-structure-based features includes determining a number of advertisements that are located above a fold dimension line. Analyzing the page-structure-based features includes determining a total area on the web page that is utilized for advertisements. Analyzing the page-structure-based features includes determining an area of space that is utilized for advertisements that are located above a fold dimension line. The computerized method can include generating context-based features based on the rendered web page, analyzing the context-based features, and storing one or more context-based variables for each of the web pages based on the analysis. The look-alike input seed can include one or more keywords, and the scoring factors are can be calculated based on the received look-alike input seed, the stored page-structure-based variables and the stored context-based variables.

An example of a system for identifying and scoring look-alike websites according to the disclosure includes a data storage component, at least one processor configured to receive a first URL string, render a first web page based on the first URL, such that the first web page includes page-structure-based features and context-based features, analyze the page-structure-based features and context-based features to generate one or more first-page-structure-based variables and one or more first-context-based variables, store the one or more first-page-structure-based variables and one or more first-context-based variables in the data storage component, receive a look-alike input seed, calculate a matching score based on the look-alike input seed and the one or more first-page-structure-based variables and one or more first-context-based variables, and output the matching score.

Implementations of such a system may include one or more of the following features. The look-alike input seed includes a second URL string, and the at least one processor is configured to render a second web page based on the second URL string (the second web page having page-structure-based features and context-based features), analyze the page-structure-based features and context-based features in the second web page to generate one or more second-page-structure-based variables and one or more second-context-based variables, and calculate a matching score based on the first-page-structure-based variables, the second-page-structure-based variables, the first-context-based variables, and the second-context-based variables. The look-alike input seed includes one or more keywords. The processor is configured to analyze the first web page to determine a number of advertisements located above a fold dimension line. The processor is configured to analyze the first web page to determine a number of advertisements located to the left of a longitudinal dimension line. The processor is configured to analyze the first web page to determine a percentage of area utilized by advertisements as a function of the total viewable area of the website. The processor is configured to analyze the first web page to determine a number of banner advertisements located on the page.

An example of a look-alike website searching and scoring application embodied on a computer-readable storage medium for enabling the identification of look-alike URLs according to the disclosure includes a harvest workers and feature generation code segment to enable a server node to receive a URL, analyze a web page associated with the URL, generate page-structure-based features, and condense the page-structure-based features to a collection of page-structure-based variables, a data storage code segment to enable writing, storage and retrieval of the collection of page-structured-based variables for plurality of URLs in a data storage device, a look-alike slave code segment to enable a server to receive look-alike input seed information, compare the look-alike input seed information to the page-structure-based variables for the plurality of URLs in the data storage device; and generate a list of relevant URLs, and a page scoring code segment to receive the list of relevant URLs, calculate a matching score based on the look-alike input seed information and the list of relevant URLs, and output a page scoring list. Implementations of such a computer-readable storage medium may include one or more of the following features. The harvest workers and feature generation code segment is configured to generate context-based features and the page scoring code segment is configured to calculate a matching score based on the context-based features. The computer-readable storage medium may include user interface component to receive the look-alike input seed information from a user, an Application Program Interface (API) component configured receive the look-alike input seed information from a computer network, and output the page scoring list to a computer network.

An example of a website scoring system according to the disclosure includes means for generating a first set of page-structure-based features for a first website, means for generating a second set of page-structure-based features for a second website, means for calculating a scoring factor based on the first and second page-structure-based features, and means for outputting the scoring factor.

In accordance with implementations of the invention, one or more of the following capabilities may be provided. A web crawler can capture (i.e., harvest) text and page layout data from a domain/URL (e.g., a website). The context of the text can be analyzed. The page layout data can be condensed. The captured text and page layout data can be stored in a database and searched. A user can provide seed data, including keywords and/or one or more desirable URLs. The seed data can be analyzed and compared to the database. Look-alike web pages can be identified and scored. Look-alike scoring factors can be used in an ad exchange interface. These and other capabilities of the invention, along with the invention itself, will be more fully understood after a review of the following figures, detailed description, and claims.

### BRIEF DESCRIPTION OF THE FIGURES

FIGS. 1A and 1B depict an exemplary computer system which can be used for look-alike webpage scoring.

FIG. 2 is an exemplary display layout for a rendered web page.

FIG. 3 is an exemplary list of variables associated with one or more web page files.

FIG. 4 is a block diagram of a system for enabling a page scoring process.

FIG. 5 includes exemplary flow diagrams of processes for storing condensed page information.

FIG. 6 is an exemplary flow diagram of a process for outputting a page scoring list.

FIG. 7 is an exemplary flow diagram of a process for searching condensed page information.

FIG. 8 includes examples of an input seed and a page scoring list.

### DETAILED DESCRIPTION OF PREFERRED EMBODIMENTS

Embodiments of the invention provide techniques for harvesting and scoring look-alike websites. This system is exemplary, however, and not limiting of the invention as other implementations in accordance with the disclosure are possible.

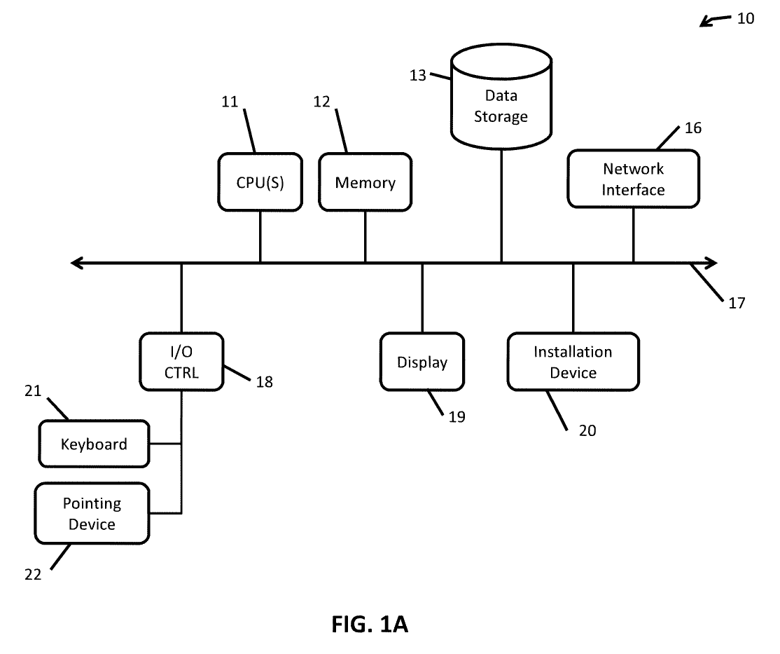

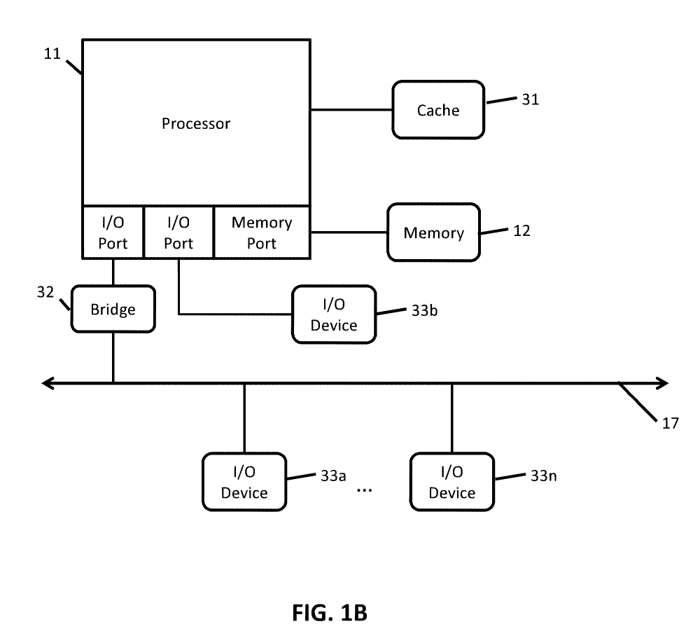

Referring to FIGS. 1A and 1B, block diagrams of a computing device 10 which may be useful for practicing an embodiment of the Look-Alike Website Scoring system are shown. The system can include one or more software applications that may be deployed as and/or executed on any type and form of computing device, such as a computer, network device, server, database, or appliance capable of communicating on any type and form of network and performing the operations described herein. Each computing device 10 can include one or more central processing unit(s) 11, and a main memory unit 12. As shown in FIG. 1A, a computing device 10 may include a visual display device 19, a keyboard 21 and/or a pointing device 22, such as a mouse, touch pad, or touch screen. Referring to FIG. 1B, each computing device 10 may also include additional optional elements, such as one or more input/output devices 33a-33n (generally referred to using reference numeral 33), and a cache memory 31 in communication with the central processing unit 11.

The central processing unit(s) 11 (i.e., the processor) can be any logic circuitry that responds to and processes instructions fetched from the main memory unit 12. In many embodiments, the central processing unit is provided by a microprocessor unit, such as: those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 10 may be based on any of these processors, or any other processor capable of executing computer-readable instructions.

Main memory unit 12 may be one or more memory chips capable of storing data and allowing any storage location to be directly accessed by the microprocessor 11, such as Static random access memory (SRAM), Dynamic random access memory (DRAM), synchronous DRAM (SDRAM), and other memory configuration used in computer systems. In the embodiment shown in FIG. 1A, the processor 11 communicates with main memory 12 via a system bus 17. In an embodiment, the processor 11 communicates directly with main memory 12 via a memory port. For example, in FIG. 1B the main memory 12 may be DRDRAM.

FIG. 1B depicts an embodiment in which the processor 11 communicates directly with cache memory 31 via a secondary bus, sometimes referred to as a backside bus. The processor 11 can communicate with cache memory 31 using the system bus 17. The processor 11 can also communicate with various I/O devices via a local system bus 17. Various busses may be used to connect the central processing unit 11 to any of the I/O devices (e.g., VESA, ISA, EISA, etc.). The processor 11 can be configured to use an Advanced Graphics Port (AGP) to communicate with the display 19. FIG. 1B depicts a computer 10 in which the main processor 11 communicates directly with I/O device 33b via HyperTransport, Rapid I/O, or InfiniBand. The processor 11 can be configured to communicate with I/O device 33a using a local interconnect bus while communicating with I/O device 33b directly.

The computing device 10 may support any suitable installation device 20 configured to receive a computer-readable storage medium, such as, a CD-ROM drive, a CD-R/RW drive, a DVD-ROM drive, tape drives of various formats, a USB device, a hard-drive, a network connection, or any other device suitable for installing software and programs, or portion thereof. The computing device 10 may further comprise a storage device 13, such as one or more hard disk drives or redundant arrays of independent disks, for storing an operating system, computer-readable instructions, and application components. Optionally, any of the installation devices 20 could also be used as the storage device 13. Additionally, the operating system and the software can be run from a bootable medium, for example, a bootable CD, such as KNOPPIX™, a bootable CD for GNU/Linux that is available as a GNU/Linux distribution from knoppix.net.

The computing device 10 may include a network interface 16 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 16 may comprise a built-in network adapter, network interface card, PCMCIA network card, card bus network adapter, wireless network adapter, USB network adapter, modem or any other device suitable for interfacing the computing device 10 to any type of network capable of communication and performing the operations described herein.

A wide variety of I/O devices 33a-33n (not all shown) may be present in the computing device 10. Input devices include keyboards, mice, trackpads, trackballs, microphones, and drawing tablets. Output devices include video displays, speakers, inkjet printers, laser printers, and dye-sublimation printers. The I/O devices 33 may be controlled by an I/O controller 18 as shown in FIG. 1A. The I/O controller may control one or more I/O devices such as a keyboard 21 and a pointing device 22, e.g., a mouse or optical pen, touch pad, touch screen. Furthermore, an I/O device may also provide storage 13 and/or an installation medium 20 for the computing device 10. In still other embodiments, the computing device 10 may provide USB connections to receive handheld USB storage devices.

An I/O device may be a bridge 32 between the system bus 17 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 30 of the sort depicted in FIGS. 1A and 1B typically operate under the control of operating systems, which control scheduling of tasks and access to system resources. The computing device 10 can be running any operating system such as any of the versions of the Microsoft® Windows operating systems, the different releases of the Unix and Linux operating systems, any version of the Mac OS® or OS X for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS XP, WINDOWS Server and WINDOWS 7 all of which are manufactured by Microsoft Corporation of Redmond, Wash.; MacOS and OS X, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, (such as those versions of Unix referred to as Solaris/Sparc, Solaris/x86, AIX IBM, HP UX, and SGI (Silicon Graphics)), among others. In other embodiments, the computing device 10 may have different processors, operating systems, and input devices consistent with the device. Moreover, the computing device 10 is typically a server, but can be any workstation, database, desktop computer, laptop or notebook computer, handheld computer, mobile telephone, smart phone, any other computer, or other form of computing or telecommunications device that is capable of communication and that has sufficient processor power and memory capacity to perform the operations described herein.

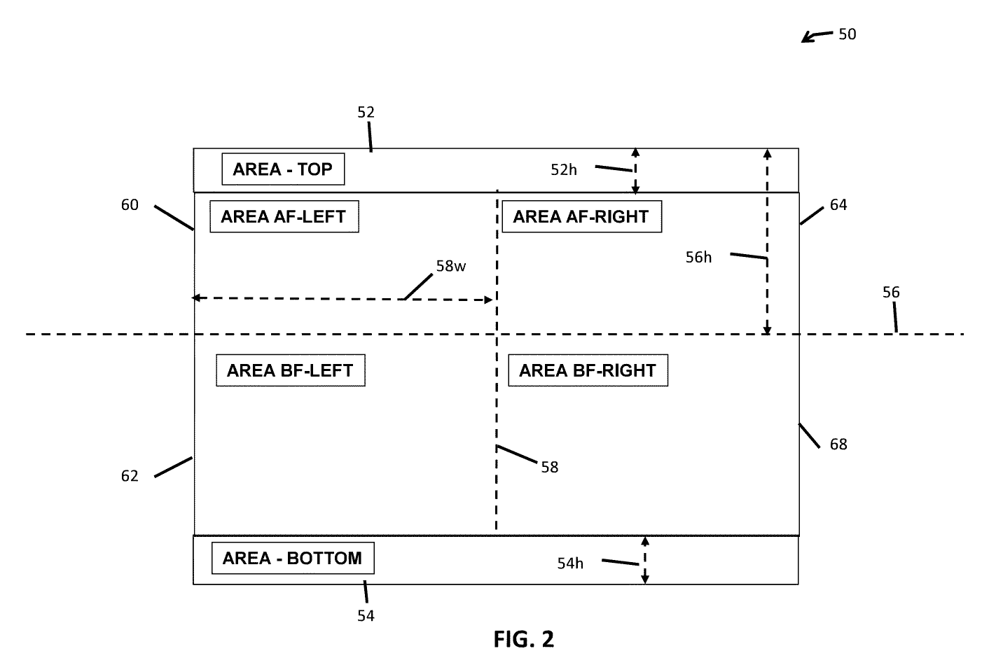

Referring to FIG. 2, an exemplary display layout 50 for a rendered web page is shown. The layout 50, however, is exemplary only and not limiting. The layout 50 may be altered, e.g., by including additional areas and by varying the positions of the dimension lines. The layout 50 represents a typical web page as displayed on a viewing screen (e.g., a monitor, internet appliance, smart phone, tablet). The layout 50 includes a top area 52, a bottom area 54, a fold dimension line 56, and a longitude dimension line 58. The fold dimension line 56 generally indicates the bottom of the monitor when the page is initially rendered. That is, the initial height of the view screen 56h is displayed, and a user may have to utilize a scroll down function in a browser to see the content in the areas below the fold dimension line 56. For example, the initial height of the view screen 56h is 700 pixels. The relative location of the longitude dimension line 58 can be more arbitrary, but the position generally represents the center of the viewing screen. For example, the distance 58w from the left edge of the viewing screen to the longitude dimension line 58 is 512 pixels. Similarly, as an example, the height of the top area 52h and the bottom area 54h are 100 pixels each. Based on the position of the fold dimension line 56 and the longitudinal dimension line 58, the layout 50 can be further subdivided into an area above the fold left (AF Left) 60, an area below the fold left (BF Left) 62, an area above the fold right (AF Right) 64, and an area below the fold right (BF Right) 68. These areas are exemplary only, and not a limitation, as additional areas and subdivisions can used in a look-alike analysis described herein.

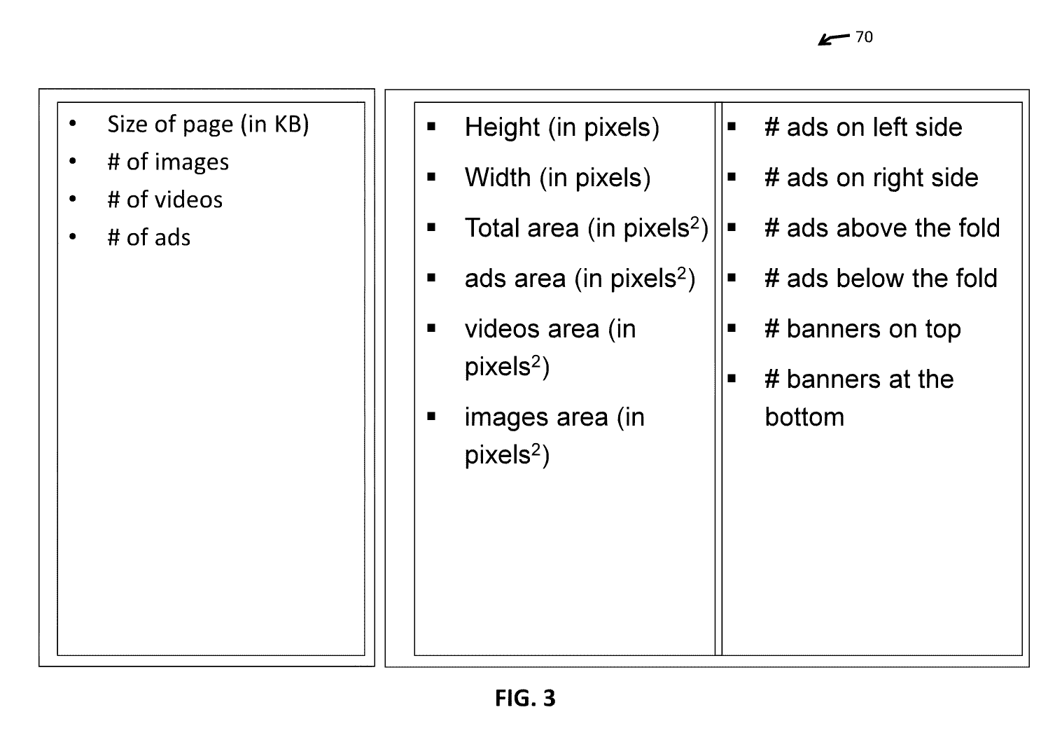

Referring to FIG. 3, with further reference to FIG. 2, a collection of variables 70 associated with page-structure-based features in a rendered web page is shown. The collection 70 is exemplary, and not a limitation, as additional variables and features may be determined and stored. The variables 70 can be stored as a data structure with fields including data representing one or more of the corresponding page-structure-based features. A computer system 10 can be configured to access a URL and perform an analysis on one or more pages associated with the URL to determine values for the variables in the collection 70. The analysis can include determining the size of the web page in term of the memory used to store the associated web page files. For example, a typical web page includes a collection of objects (e.g., files) stored on a web server. Some of these files can be loaded onto the computer 10 when the web page is rendered, and the resulting use of memory can be determined. The web page may include a number of images, videos and ads. The count of each of the images, videos and ads can be determined and stored. The overall height and width of the rendered page can be determined and stored. The units of the stored dimensions can in pixels or other units of measurement. The total area of the rendered page can be determined and stored (e.g., in pixels²). The area of space on the web page devoted to objects such as ads, text blocks, videos, and images can also be stored. A comparison between the total area and the area used for each of the objects can be made and the results stored as a percentage value (e.g., 17% ads, 20% images, 10% video). The number and relative locations of the ads on the page can be determined and stored. The number of ads, and the area used by the ads on the right or left of the longitudinal dimension line 58, above or below the fold dimension line 56, or in the top and bottom banners 52, 54 can be determined and stored. The object and ad information can be grouped and stored according to the areas defined by the layout 50 (e.g., AF Left, AF Right, BF Left, BF Right). Other ratios can also be determined, such as the percentage of ads below the fold, the percentage of ads in the top or bottom, the percentage of ads on the right or the left. Further comparisons of these ratios can also be determined, such as a ratio between the count, or area utilized, of ads on the right versus the left, or the top versus the bottom. The count of, or area used by, ads can also be compared to equivalent values for other objects on the page, such as images, video and text blocks.

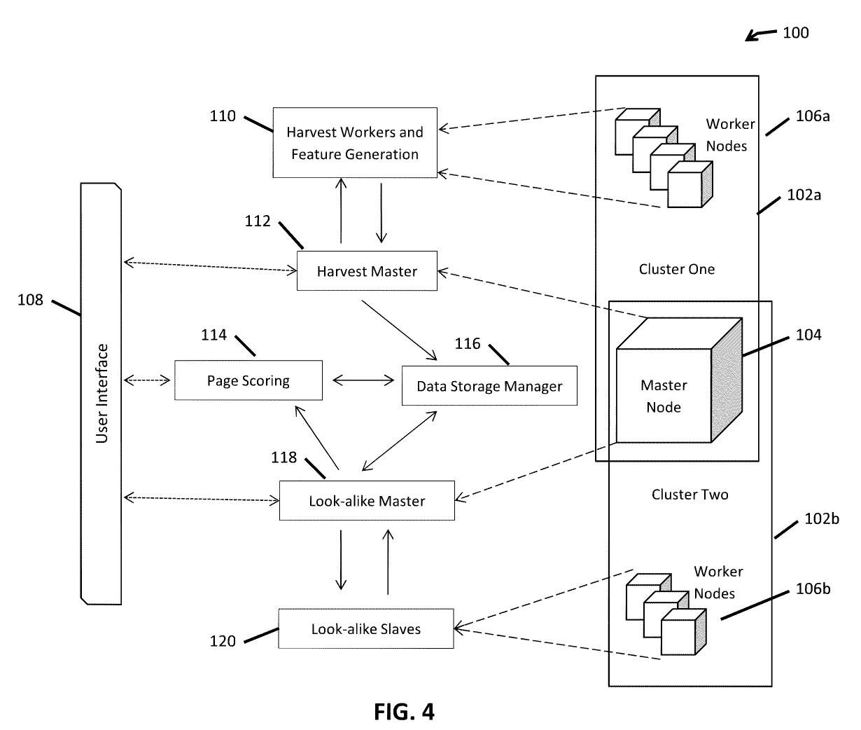

Referring to FIG. 4, a block diagram of a system 100 for enabling a page scoring process is shown. In an embodiment, the system 100 includes two computer clusters 102a, 102b including a master node 104 and worker nodes 106a, 106b. In general, the master and worker nodes 104, 106a, 106b include one or more computers 10 (e.g., servers) in communication with one another and the Internet, configured to execute one or more software modules. For example, the plurality of servers in worker nodes 106a in cluster one 102a can be configured to execute the harvest workers and feature generation software module 110. The number of servers in a worker node 106a, 106b can be scaled based on the amount of data to be analyzed. In an exemplary configuration, cluster one 102a includes 33 servers as worker nodes 106a, and a single server as a master node 104. Cluster two 102b can include 16 servers as worker nodes 106b, and utilize the same master node 104 with cluster one 102a. The master node 104 can be configured to execute a user interface software module 108, a harvest master software module 112, a page scoring software module 114, a data storage manager 116, a look-alike master software module 118. The worker nodes 106b in cluster two 102b can be configured to execute a look-alike slave software module 120. The system 100 is exemplary only, and not a limitation. The system may include additional nodes and the software modules (110, 112, 114, 116, 118, 120) can be executed within the different nodes.

In operation, the harvest master module 112 is configured to coordinate the harvesting of web pages from the Internet. The harvest master 112 can receive a list of URLs to be harvested from a user interface 108, or other input method (i.e., file transfer, API call). In an embodiment, the user interface 108 executes in a web browser. Based on the number of URLs to be harvested, the harvest master 112 can utilize load balancing algorithms to help optimize the use of the servers 10 in the worker nodes 106a. The harvest master 112 then receives the harvested web page information from the worker nodes 106a and stores them via the data storage manager 116 on the master node 104. The harvest workers and feature generation module 110 receives requests from the harvest master 112. The requests include URLs that the worker nodes 106a are to access and programmatically render. Referring back to FIGS. 2 and 3, the harvest workers and feature generation module 110 is configured to analyze one or more pages associated with each URL and generate page-structure-based features and context-based features. The module 110 then condenses the page-structure-based features to a collection of variables 70. The context-based features are analyzed for keywords and other semantic relationships, and can be condensed into one or more context-based variables. For example, each word can be reviewed. Common words can be removed, and the location of the remaining words can be analyzed. A list of keywords can be stored. Other contextual analysis as known in the art may also be used. The harvest workers and feature generation module 110 performs a condensation of the context-based features and stores them as context-based variables on the master node 104 via the data storage manager 116.

The data storage manager 116 can be a relational database (e.g., Microsoft SQL server, Oracle), or other application configured to facilitate the storing and retrieving of computer readable information. In an embodiment, the condensed harvested page information can be received as one or more flat files (e.g., XML) and the data storage manager 116 is configured to access and retrieve data from the flat files. The page scoring module 114 is configured to receive the condensed harvested page information from the data storage manager 116, determine one or more scoring factors for each URL, and output the scoring factors to a user interface 108. For example, the scoring factors can include relative indexes of the number of ads on a page, and the likelihood that an ad will be placed above or below the fold (e.g., High, Even, Low). As will be discussed, the scoring factor may also include a match score when comparing the harvested page information to a seed page.

The look-alike master module 118 is configured to receive seed information from the user interface 108 and determine relevant URLs based on the seed data. In an embodiment, the seed data can include keywords and one or more desired URLs. The look-alike master module 118 can have the URLs associated with the desired URLs (i.e., the look-alike URL) rendered and then have the condensed look-alike page information stored. The look-alike master module 118 can task the look-alike slave modules 120 on the worker nodes 106b to compare the condensed look-alike page information and the seed keywords to the condensed harvest information stored on the master node 104. The look-alike master module 118 can utilize load balancing algorithms in an effort to optimize the computing resources in the worker node 106b. In general, the algorithms used to compare the page information include large scale matrix computations. From a processing perspective, the matrix computations can be decomposed into smaller computational tasks and divided among the processors in the worker nodes 106b. The processing results can be recombined to form approximate solutions. Based on the comparison, the look-alike master module 118 can provide a list of relevant URLs to the page scoring module 114 to determine the relevant scoring factors and present the list to the user.

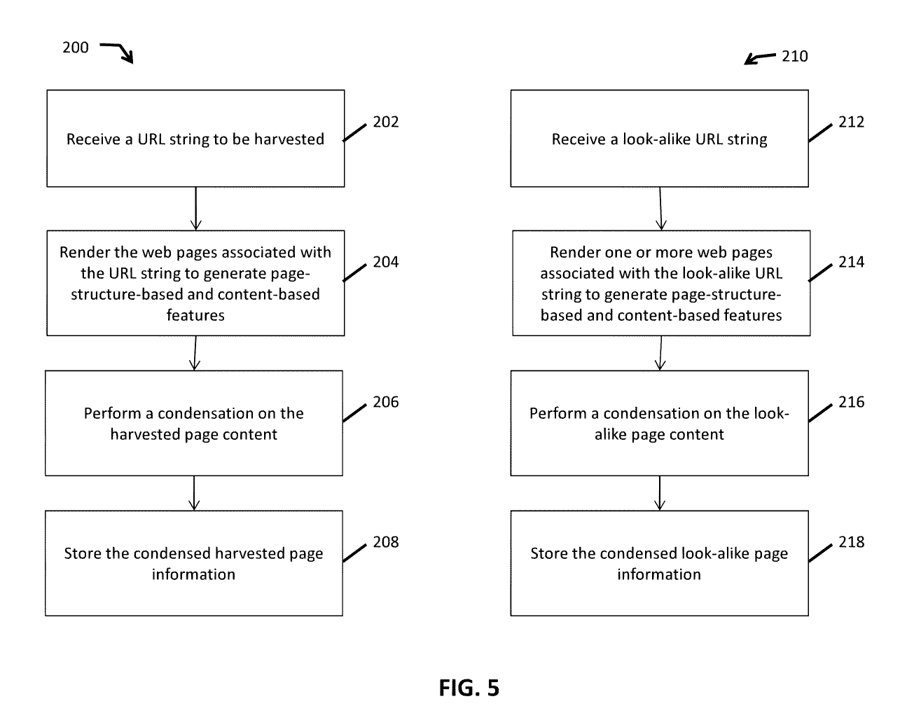

In operation, referring to FIG. 5, with further reference to FIG. 4, processes 200, 210 for storing condensed harvested page information and for storing condensed look-alike page information using the system 100 includes the stages shown. The processes 200, 210, however, are exemplary only and not limiting. The processes 200, 210 may be altered, e.g., by having stages added, removed, or rearranged.

Referring to the web crawling (i.e., URL harvesting) process 200, at stage 202 the harvest workers and feature generation module 110 can receive on or more URL strings to be harvested. The URL strings can be received from harvest master module 112 via the user interface 108. In an embodiment, the URL strings can supplied via the network through a communications interface (e.g., an API, web service, ODBC connection, SOAP). At stage 204, each URL is accessed via the World Wide Web and the corresponding web pages are rendered programmatically within the feature generation module 110 to generate the page-structure-based and content-based features. For example, the number and relative location of page-structure-based objects can be determined, and the content of the text elements can be analyzed. In that the technology and styles (i.e., framework) associated with web pages can vary, the feature generation module 110 can include a framework analysis component configured to modify the rendering process based on the native framework of the web page. At stage 206 the page-structure-based and content-based features information can be condensed to one or more data variables. For example, the page-structure-based features of the harvested page can be condensed to a collection of variables 70, and the content-based features of the harvested page can be stored as one or more keywords. At stage 208 the URL string and the condensed harvested page information can be stored on the master node 104 via the data storage manager 116. In an embodiment, the data storage manager can be a relational database and the condensed harvested page information can be one or more records in a database. The data storage manager 116 can be other software applications configured for reading and writing data to a storage device, such as with a flat file configuration, or other data structures.

Referring to the look-alike page condensation process 210, at stage 212 the look-alike master can receive one or more URL strings from the UI 108. In general, the look-alike URLs correspond to web sites an advertiser feels are an appropriate place to display an ad. The decision on which look-alike URLs to select can be subjective, i.e., based on the advertisers impressions of layout and content of the desired look-alike URL. The decision may also be based on empirical results such as click stream data, sales revenue generated, or other metrics used to determine the effectiveness of an ad. The advertiser may have a very favorable response on a first web site and then use that URL as the look-alike URL in an effort to find similar websites to duplicate the favorable response. In an embodiment, the look-alike URL string can be received via an analytics engine configured to improve the effectiveness of ads by monitoring results and providing look-alike URLs on a periodic basis. At stage 214, the look-alike URL string can be provided to the feature generation module 110 and rendered programmatically to generate the page-structure-based and content-based features as previously described. At stage 216 the look-alike page-structure-based and content-based features information can be condensed to one or more data variables and stored at stage 218. In an embodiment, the data storage manager 116 can search a data storage device to determine if the look-alike URL and the corresponding condensed page information exists (e.g., as the result of previous processing of the URL). The stored condensed page information can be validated (e.g., by date stamp or other validation rule) to determine whether the URL needs to be rendered and condensed (i.e., updated).

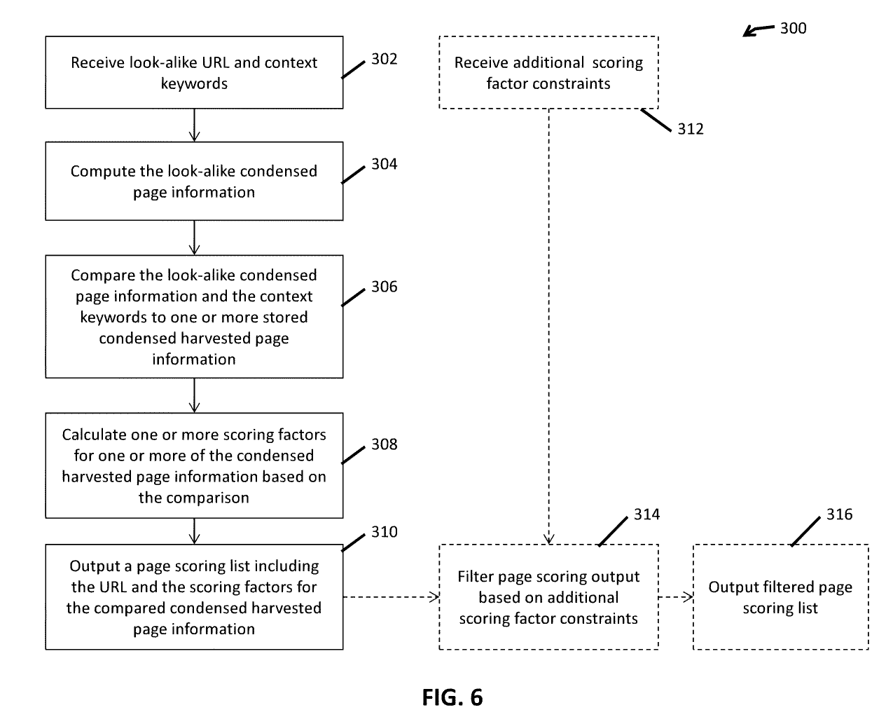

Referring to FIG. 6, with further reference to FIGS. 4 and 5, a process 300 for outputting a page score list using the system 100 includes the stages shown. The process 300, however, is exemplary only and not limiting. The process 300 may be altered, e.g., by having stages added, removed, or rearranged.

At stage 302 one or more look-alike URLs and context keywords can be received. The look-alike URLs and keywords can be entered via the user interface 108, or pushed to the look-alike master 118 from another computer system (e.g., analytic engine, web service, custom API). At stage 304 the look-alike condensed page information can be computed via the process 210, or via a search with the data storage manager 116.

At stage 306, the look-alike condensed page information and the context keywords are compared to the condensed harvested page information stored via the data storage manager 116. In an embodiment, the look-alike master module 118 can instruct the look-alike slave modules 120 to access portions of the stored harvested page information. The look-alike master module 118 can utilize load balancing algorithms to distribute the processing tasks amongst the processors in the worker nodes 106b. For example, a server 10 in the worker node 106b can query the stored data using the keywords to produce a constrained dataset. The dataset can be further constrained based on the page-structure-based variables. Other data comparison or filtering techniques may also be used.

At stage 308, the look-alike slaves module 120 can calculate one or scoring factors for one or more of the condensed harvested page information based on the comparison. In general a scoring factor can be assigned by a semi-supervised machine learning algorithm developed from historical data associated with web page features. The scoring can include a component reflecting a human judgment about the quality of a web page. Singular Value Decomposition (SVD) methods can be applied to the condensed harvested page information. A scoring factor can be based on the cosine distance between the page information in SVD space. For example, distance values can be determined by comparing vectors derived from the look-alike condensed page information and the context keywords, and vectors derived from the stored condensed harvest page information.

At stage 310, the look-alike master module 118 can receive the results of the scoring algorithms from the look-alike slaves module 120 and output a page scoring list including the URL and the scoring factors for the condensed harvested page information compared at stage 306. The output can be presented via the user interface 108, or pushed to another application (e.g., web services, API).

Stages 312, 314 and 316 are optional as indicated by the dashed lines on FIG. 6. In an embodiment, at stage 312, the user can provide additional scoring factor constraints to filter the page scoring list provided at stage 310. The additional constraints may allow the user to narrow the page score list to specific criterion. For example, a user may request that the list be filtered to show only web sites that pertain to a particular industry segment; show only web pages that place advertisements above the fold; show only web pages that have less than four advertisements. Other criteria, alone or in combination, may be used to constrain the page scoring list.

At stage 314, the additional scoring constraints received at stage 312 can be used to filter the page scoring list of stage 310. For example, in a database implementation, a SQL stored procedure can execute a select query with values associated with the additional scoring constraints (e.g., num_ads<=4; num_adsbelowfold=0). Keywords and context limits can be used as additional scoring constraints. The filtered page scoring list can be output at stage 316.

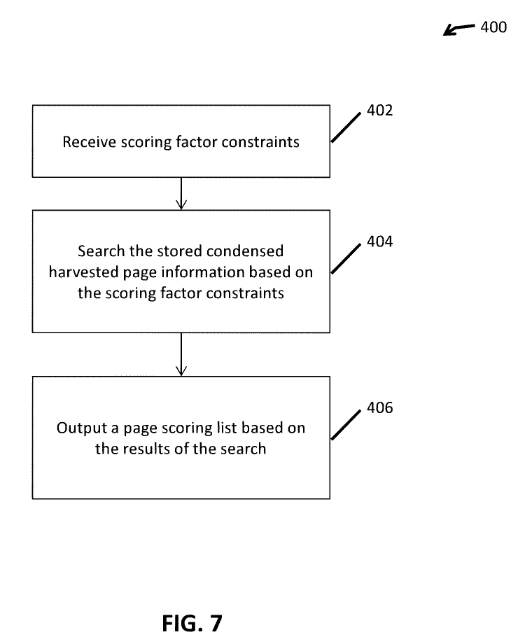

In operation, referring to FIG. 7, with further reference to FIG. 5, a process 400 for searching the condensed page information using the system 100 includes the stages shown. The process 400, however, is exemplary only and not limiting. The process 400 may be altered, e.g., by having stages added, removed, or rearranged.

At stage 402 the look-alike master 118 can receive one or more scoring factor constraints. In an embodiment, a user may not have identified a look-alike URL that they wish to emulate. Rather, the user may have a general idea of the type of web page they want to advertise on. In this case, the use can enter one or more scoring factor constraints into the user interface 108, or via other input methods, to produce a page scoring list. For example, a combination of keyword values for the condensed page variables 70 can be used as scoring factor constraints. Generalized scoring factors may also be used. For example, values associated with one or more of the condensed page variables 70 can be quantified into general groups such as Low, Medium, High (e.g., less than 4 ads on a page is Low, 5-8 ads is Medium, more than 8 is High). Other ratios derived from the variables 70 can also be grouped. For example, pages with a high percentage of ads below the fold can be characterized as having a High Likelihood of placing a new ad below the fold. Similar relationships can be used of Low Likelihood and Even Likelihood groups. These and other group values can be used as scoring factor constraints (i.e., at stages 312 and 402).

At stage 404 the look-alike master module 118 can direct the look-alike slave modules 120 on the worker nodes 106b to search the stored condensed harvested page information based on the scoring factor constraints received at stage 402. As previously discussed, load balancing algorithms can be used to increase the efficiency of the available processors. The results of the search can be output as a page scoring list at stage 406. The page scoring list information can be available via the user interface 108, or pushed to other computer systems via a communication protocol.

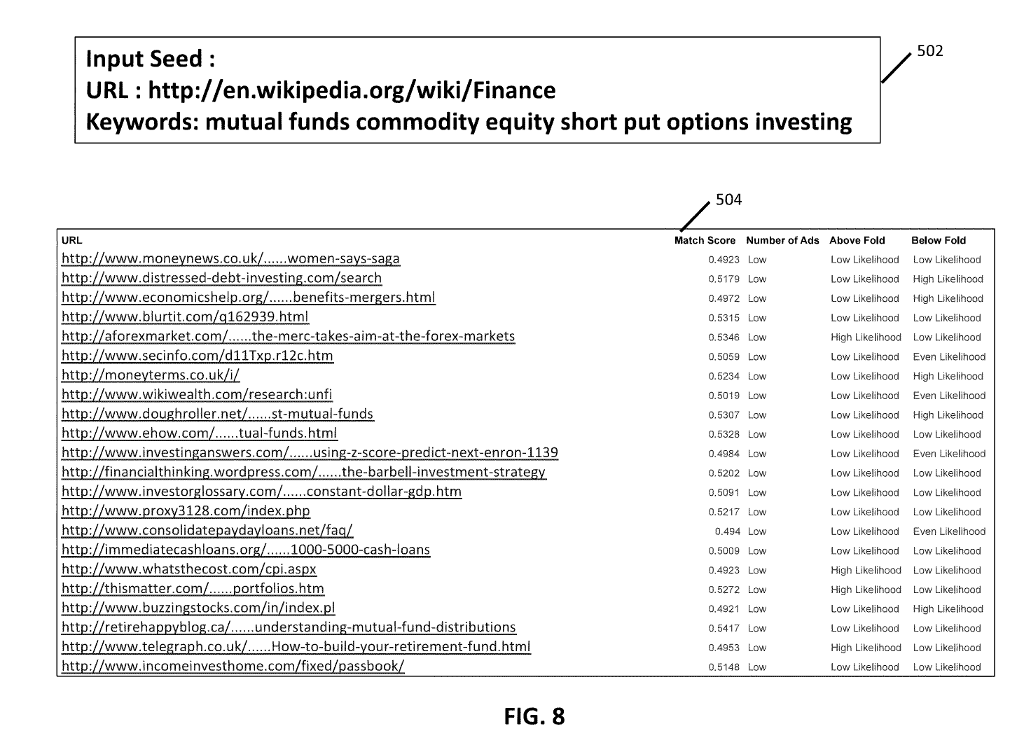

Referring to FIG. 8, with further reference to FIGS. 6 and 7, examples of an input seed 502 and page scoring list 504 are shown. The look-alike master module 118 can receive the input seed 502 via the user interface 108, or other computer communication method. In this case, the input seed includes a desired URL string “http://en.wikipedia.org/wiki/Finance” and the context keywords: “mutual funds commodity equity short put options investing.” At stage 304, the look-alike condensed page information for the web page at “http://en.wikipedia.org/wiki/Finance” can be computed and stored. The remaining stages of the process 300 can be executed and the page scoring list 504 can be produced at stage 310. As an example, and not a limitation, the data structure on the page scoring list 504 includes fields for a URL string, a match score, a number of ads group value, an above fold group value, and a below fold group value. Other fields related to the condensed page variables 70 may also be included on the page scoring list 504. The list 504 can be provided to the UI 108 and optionally filtered at stage 314.

In an embodiment, the page scoring list 504 can be used in conjunction with an ad exchange to provide an approved list of URLs that the advertiser will place an ad. That is, the ad exchange will only place bids for URLs on the page scoring list. Additional constraints, such as those discussed at stage 312 can also be within the ad exchange application to further limit the approved URL list. For example, the value of match score value can be combined with other geographical and temporal tags in the bidding opportunity. As a result, in an example, the ad exchange can select a subset of the URLs based on lower match score for a first region and/or at a first designated time slot, an use a higher match score for a second region and/or a second designated time slot. Other combination of bidding tag and page scoring constraints may also be used.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A computerized method for identifying look-alike websites, comprising:
receiving a plurality of URL strings to be harvested;
rendering, in at least one computer, a web page associated with each of the plurality of URL strings to generate page-structure-based features;
analyzing the page-structure-based features for each of the web pages with the computer;
storing a plurality of page-structure-based variables for each of the web pages based on the analysis;
receiving a look-alike input seed;
calculating, with at least one computer, one or more scoring factors based on the received look-alike input seed and the stored page-structure-based variables; and
outputting the scoring factors.

2. The computerized method of claim 1 wherein the look-alike input seed includes a URL string.

3. The computerized method of claim 1 wherein analyzing the page-structure-based features includes determining a number of advertisements that are located above a fold dimension line.

4. The computerized method of claim 1 wherein analyzing the page-structure-based features includes determining a total area on the web page that is utilized for advertisements.

5. The computerized method of claim 1 wherein analyzing the page-structure-based features includes determining an area of space that is utilized for advertisements that are located above a fold dimension line.

6. The computerized method of claim 1 comprising:
generating context-based features based on the rendered web page;
analyzing the context-based features; and
storing one or more context-based variables for each of the web pages based on the analysis.

7. The computerized method of claim 6 wherein the look-alike input seed includes one or more keywords, and the scoring factors are calculated based on the received look-alike input seed, the stored page-structure-based variables and the stored context-based variables.

8. A system for identifying and scoring look-alike website, comprising:
a data storage component;
at least one processor configured to:
receive a first URL string;
render a first web page based on the first URL, wherein the first web page includes page-structure-based features and context-based features;
analyze the page-structure-based features and context-based features to generate one or more first-page-structure-based variables and one or more first-context-based variables;
store the one or more first-page-structure-based variables and one or more first-context-based variables in the data storage component;
receive a look-alike input seed;
calculate a matching score based on the look-alike input seed and the one or more first-page-structure-based variables and one or more first-context-based variables; and
output the matching score.

9. The system of claim 8 wherein the look-alike input seed includes a second URL string, and the at least one processor is configured to:
render a second web page based on the second URL string, wherein the second web page includes page-structure-based features and context-based features;
analyze the page-structure-based features and context-based features in the second web page to generate one or more second-page-structure-based variables and one or more second-context-based variables; and
calculate a matching score based on the first-page-structure-based variables, the second-page-structure-based variables, the first-context-based variables, and the second-context-based variables.

10. The system of claim 8 wherein the look-alike input seed includes one or more keywords.

11. The system of claim 8 wherein the processor is configured to analyze the first web page to determine a number of advertisements located above a fold dimension line.

12. The system of claim 8 wherein the processor is configured to analyze the first web page to determine a number of advertisements located to the left of a longitudinal dimension line.

13. The system of claim 8 wherein the processor is configured to analyze the first web page to determine a percentage of area utilized by advertisements as a function of the total viewable area of the website.

14. The system of claim 8 wherein the processor is configured to analyze the first web page to determine a number of banner advertisements located on the page.

15. A look-alike website searching and scoring application embodied on a computer-readable storage medium for enabling the identification of look-alike URLs, comprising:
a harvest workers and feature generation code segment to enable a server node to receive a URL, analyze a web page associated with the URL, generate page-structure-based features, and condense the page-structure-based features to a collection of page-structure-based variables;
a data storage code segment to enable writing, storage and retrieval of the collection of page-structured-based variables for plurality of URLs in a data storage device;
a look-alike slave code segment to enable a server to receive look-alike input seed information, compare the look-alike input seed information to the page-structure-based variables for the plurality of URLs in the data storage device; and generate a list of relevant URLs; and
a page scoring code segment to receive the list of relevant URLs; calculate a matching score based on the look-alike input seed information and the list of relevant URLs, and output a page scoring list.

16. The computer-readable storage medium of claim 15 wherein the harvest workers and feature generation code segment is configured to generate context-based features and the page scoring code segment is configured to calculate a matching score based on the context-based features.

17. The computer-readable storage medium of claim 15 comprising a user interface component to receive the look-alike input seed information from a user.

18. The computer-readable storage medium of claim 15 comprising an Application Program Interface (API) component configured receive the look-alike input seed information from a computer network.

19. The computer-readable storage medium of claim 15 comprising an Application Program Interface (API) component configured output the page scoring list to a computer network.

20. A website scoring system, comprising:
means for generating a first set of page-structure-based features for a first website;
means for generating a second set of page-structure-based features for a second website;
means for calculating a scoring factor based on the first and second page-structure-based features; and
means for outputting the scoring factor.
